(19) United States
(12) Patent Application Publication
(10) Pub. No.: US 2016/0192193 A1
(43) Pub. Date: Jun. 30, 2016

(54) Security Setting and Release Method in Smartphone Using Wearable Device

(71) Applicant: Sang Hoon LEE, Seoul (KR)

(72) Inventor: Sang Hoon LEE, Seoul (KR)

(21) Appl. No.: 14/582,506

(22) Filed: Dec. 24, 2014

(51) Int. Cl. H04W 12/08

(52) U.S. Cl. CPC H04W 12/08

(57) ABSTRACT

Disclosed is a security method in a smartphone using a wearable device and, more particularly, a method for maintaining security of a smartphone in an unlocked state or during use of the smartphone using a smartwatch. The security method in a smartphone using a wearable device includes providing a security application installed in the smartphone with device access authority from an operating system of the smartphone, requesting that the security application installed in the smartphone commences a service, checking a wearable device registered in the smartphone, transmitting a request for a connection verification value from the smartphone to the wearable device, receiving the connection verification value transmitted from the wearable device to the smartphone, displaying a lock screen on the smartphone, receiving an unlock input to the smartphone, receiving a return value corresponding to the unlock input transmitted from the wearable device to the smartphone, and performing an unlock operation.

### FIELD OF THE INVENTION

The present invention relates to a security method in a smartphone using a wearable device and, more particularly, to a method for maintaining security of a smartphone in an unlocked state or during use of the smartphone using a smartwatch.

### BACKGROUND

To unlock a smartphone upon beginning use of the smartphone, for example, input of a personal identification number (PIN) or pattern is generally used. This PIN or pattern input does not provide high level of security, but has an advantage of enabling relatively easy security release. However, the PIN or pattern input may cause inconvenience in a case in which a user has to manipulate the smartphone by one hand, e.g., during driving because a screen of the smartphone is too large to be manipulated by one hand.

### SUMMARY

As described above, with regard to unlocking of a smartphone, the related art has a problem in that PIN or pattern input is inconvenient in a case in which a user has to manipulate the smartphone by one hand, e.g., during driving because a screen of the smartphone is too large to be manipulated by one hand. Therefore, it is an object of the present invention to provide a technology to enable easy security release of a smartphone while maintaining a security level to prevent others from using the smartphone.

In accordance with an aspect of the present invention, to accomplish the above and other objects, a security method in a smartphone using a wearable device includes providing a security application installed in the smartphone with device access authority from an operating system (OS) of the smartphone, requesting that the security application installed in the smartphone commences a service, checking a wearable device registered in the smartphone, transmitting a request for a connection verification value from the smartphone to the wearable device, receiving the connection verification value transmitted from the wearable device to the smartphone, displaying a lock screen on the smartphone, receiving an unlock input to the smartphone, receiving a return value corresponding to the unlock input transmitted from the wearable device to the smartphone, and performing an unlock operation.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view illustrating a preferred embodiment of the present invention;

FIG. 2 is a flowchart illustrating one embodiment of a security method according to the present invention;

FIG. 3 is a view illustrating an application setup screen for provision of the security method according to the present invention;

FIG. 4 is a view illustrating one embodiment of a lock screen according to the present invention; and

FIG. 5 is a flowchart illustrating another embodiment of the security method according to the present invention.

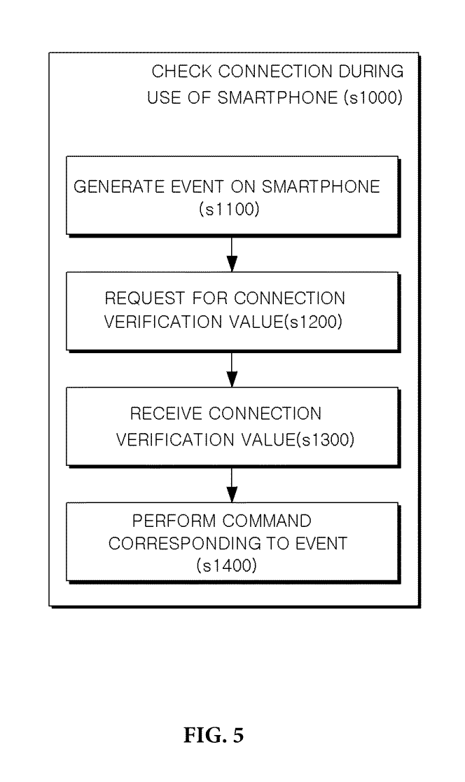

### DETAILED DESCRIPTION

In use of a smartphone, the present invention provides a method for simply unlocking or granting use permission of a smartphone using pairing with a wearable device while maintaining a security level to prevent others from releasing a lock screen or using an unlocked smartphone. To achieve the above-described object, the present invention proposes to use a security application that is installed in a smartphone and a smartwatch.

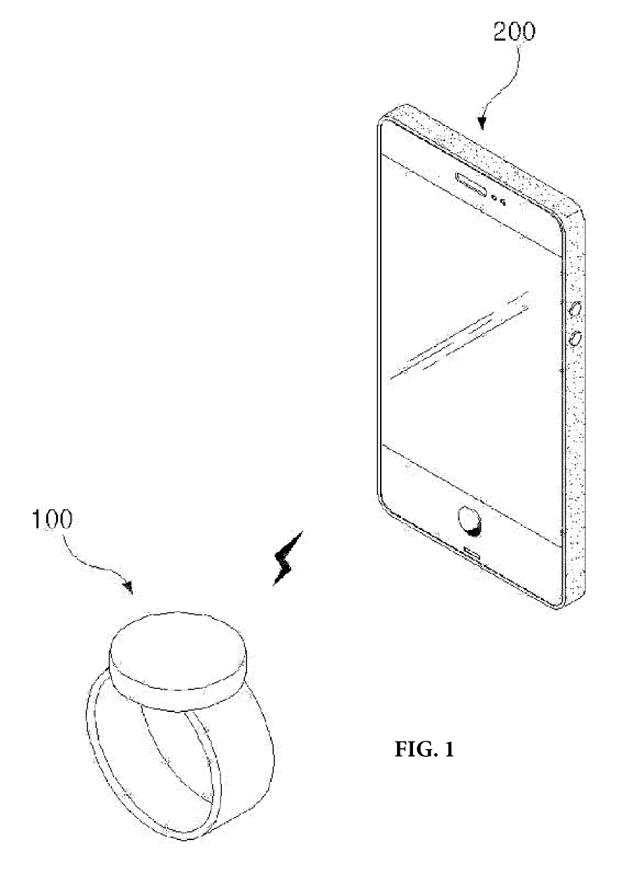

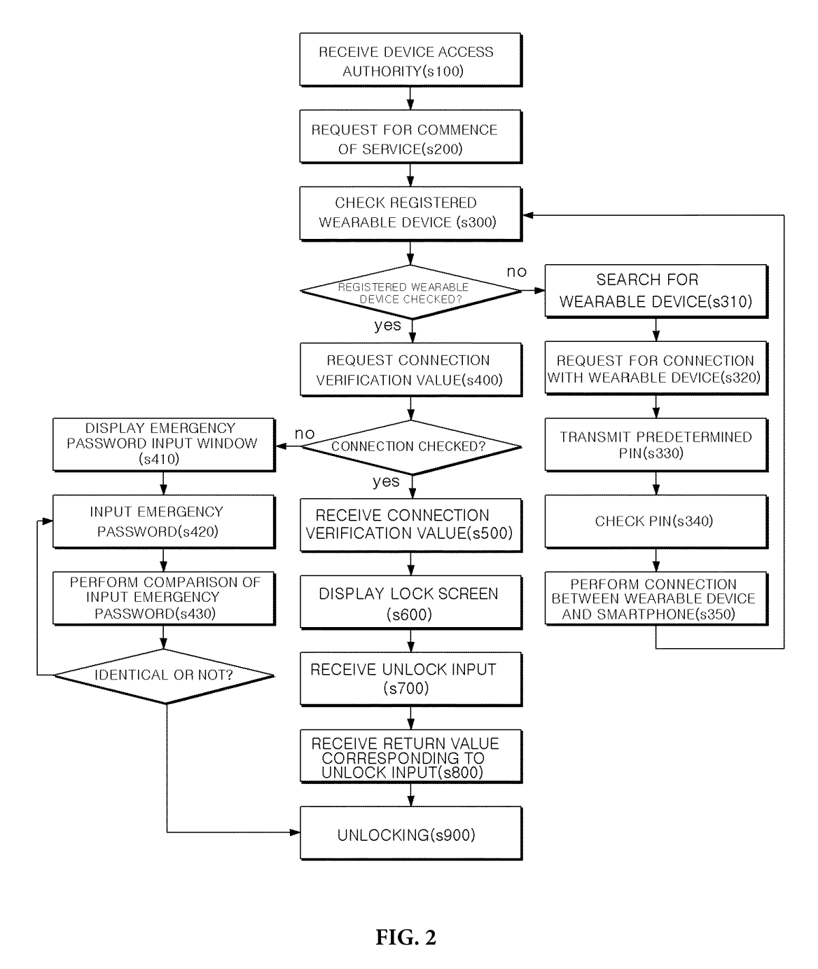

FIG. 1 is a view illustrating a preferred embodiment of the present invention, and FIG. 2 is a flowchart illustrating one embodiment of a security method according to the present invention. As exemplarily shown in FIG. 1, the present invention provides a security method in a smartphone 200 using a wearable device including: providing a security application installed in the smartphone 200 with device access authority from an operating system (OS) of the smartphone 200 (s100); requesting that the security application installed in the smartphone 200 commences a service (s200); checking a wearable device 100 registered in the smartphone 200 (s300); transmitting a request for a connection verification value from the smartphone 200 to the wearable device 100 (s400); receiving the connection verification value transmitted from the wearable device 100 to the smartphone 200 (s500); displaying a lock screen on the smartphone 200 (s600); receiving an unlock input to the smartphone 200 (s700); receiving a return value corresponding to the unlock input transmitted from the wearable device 100 to the smartphone 200 (s800); and performing an unlock operation (S900).

The wearable device 100 may be a smartwatch, smartglasses, or a smart band without being limited thereto. Particularly, the wearable device 100 is preferably a smartwatch. In addition, wireless communication for connection between the wearable device 100 and the smartphone 200 is preferably Bluetooth communication.

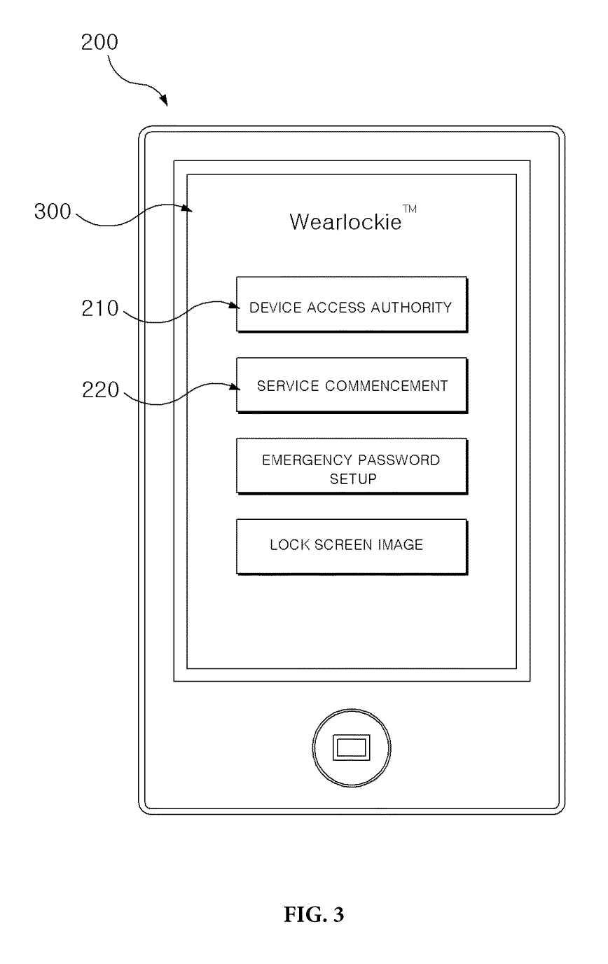

Considering the security method according to the present invention in detail, first, step s100, in which the security application installed in the smartphone 200 receives a device access authority from the OS of the smartphone 200, may be a step in which the security application requests for a device access authority to setup an initial lock screen and receives the device access authority from the OS of the smartphone 200. FIG. 3 is a view illustrating a setup screen provided by the security application for provision of the security method according to the present invention. The security application may simply acquire the device access authority from the OS as a user touches a device access authority acquisition menu item 210 displayed on the setup screen of the security application as exemplarily shown in FIG. 3.

Next, step s200, in which the user requests that the security application installed in the smartphone 200 commences a service, may be a step of determining execution of the security application according to the present invention. The user may simply allow the security application to commence a service by touching a service commence menu item 220 on the setup screen of FIG. 3.

In step s300 in which the smartphone 200 checks the wearable device 100 registered therein, the OS of the smartphone 200 checks presence of the registered wearable device 100. Upon determining, in the registered wearable device checking step s300, that no registered wearable device is present, the smartphone 200 proceeds a process of registering a wearable device using a predetermined personal identification number (PIN).

In this case, the security method in the smartphone 200 preferably includes: searching for the wearable device 100 via near field wireless communication (s310); transmitting a connection request from the smartphone 200 to the wearable device 100 via near field wireless communication (s320); transmitting a predetermined PIN from the smartphone 200 to the wearable device 100 (s330); receiving a PIN approval result transmitted from the wearable device 100 to the smartphone 200 (s340); and performing connection between the wearable device 100 and the smartphone 200 (s350).

To check connection based on near field wireless communication between the smartphone 200 and the registered wearable device 100, step S400 in which the smartphone 200 transmits a request for a connection verification value to the wearable device 100 and step s500 in which the smartphone 200 receives the connection verification value from the wearable device 100 are performed.

In a case in which the wearable device 100 has been registered, but is located at a remote place or is disconnected from the smartphone 200 due to a dead battery, the smartphone 200 cannot receive the connection verification value from the wearable device 100 despite implementation of the connection verification value request transmission step s400 in the smartphone 200. In this case, the security method in the smartphone further includes: displaying a predetermined emergency password input window on a screen of the smartphone 200 (s410); inputting an emergency password (s420); and comparing the input emergency password with a predetermined emergency password (s430), to enable use of the smartphone 200 through input of the predetermined emergency password.

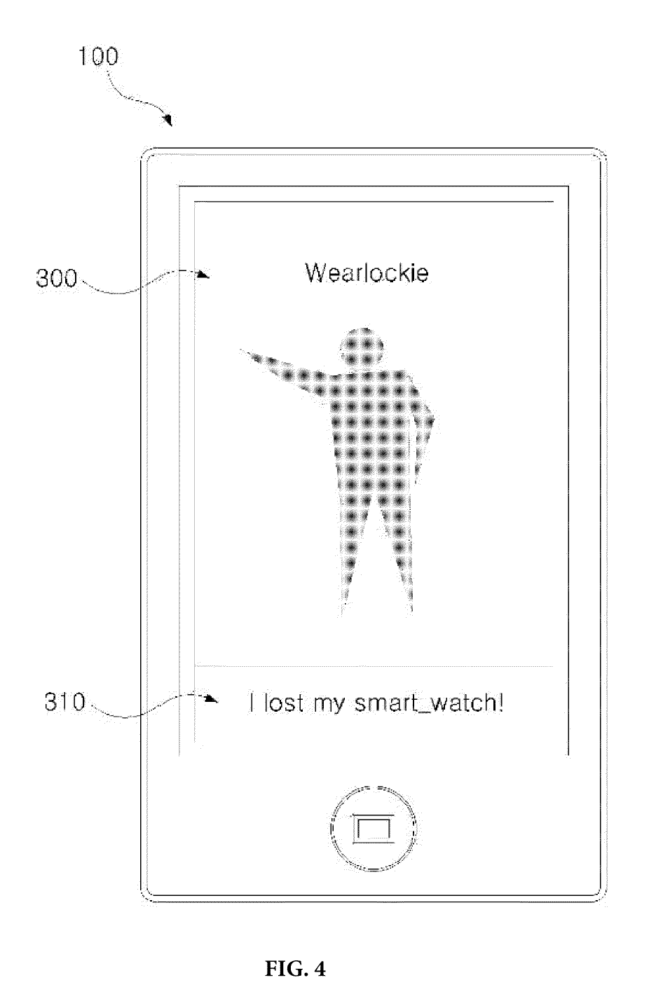

When the user turns on the smartphone 200, as exemplarily shown in FIG. 4, a lock screen 300 is displayed on the smartphone 200 in the lock screen display step s600. In this case, the lock screen 300 may be a predetermined image screen, and the predetermined image screen to be displayed is selectable by the user. In addition, an emergency password touch menu item 310 is preferably displayed in part of the displayed predetermined image screen to allow the user to input an emergency password in a state in which the smartphone 200 is not connected to the wearable device 100.

In step s700 in which the smartphone 200 receives an unlock input from the user, preferably, the user simply swipes the lock screen 300. Of course, other user motions, such as, for example, consecutively touching the lock screen 300 two or three times, may be applied.

Thereafter, the user can use the smartphone 200 through implementation of step s800 in which the smartphone 200 receives a return value corresponding to the unlock input from the wearable device 100 and step s900 in which the smartphone 200 performs an unlock operation.

In another embodiment of the present invention, the smartphone 200 may have difficulty in directly receiving the return value corresponding to the unlock input from the wearable device 100 upon display of the lock screen 300 according to the kind of the OS thereof (for example, the OS has a lower version and provides no application program interface (API)). To solve this problem, the present invention proposes to power ON or OFF a wireless communication module that is used to connect the smartphone 200 and the wearable device 100 to each other so that the smartphone 200 receives the return value corresponding to the unlock input from the wearable device 100 in an indirect manner.

More specifically, according to the present invention, the lock screen display step s600 in the smartphone 200 includes switching OFF near field wireless communication. In this case, connection between the smartphone 200 and the wearable device 100 such as a smartwatch is severed.

The unlock input reception step s700 in the smartphone 200 includes: generating a screen touch event on the smartphone 200 (s710) (not shown) and switching ON the near field wireless communication (s720) (not shown). More specifically, as a near field wireless communication module is switched ON in response to an input, such as a touch, to the lock screen 300 of the smartphone 200, the smartwatch 100 and the smartphone 200 enter a standby mode for re-connection therebetween via wireless communication.

Step s800, in which the smartphone 200 receives a return value corresponding to the unlock input from the wearable device 100, includes: generating a drag event in which the user swipes a screen with their finger (s810) (not shown); and connecting the wearable device 100 and the smartphone 200 to each other via near field wireless communication (s820) (not shown). That is, the smartphone 200 and the wearable device 100 are reconnected to each other via wireless communication in response to the drag event, which enables transmission of a connection verification value from the registered wearable device 100, such as a smartwatch, to the smartphone 200. Thereby, the smartphone 200 is unlocked in response to the connection verification value, thereby allowing the user to use the smartphone 200.

In a further embodiment, instead of receiving the unlock input to the lock screen 300 of the smartphone 200, the wearable device 100 may directly receive an unlock input to a screen thereof. In this case, likewise, the unlock input may be swiping or consecutive touches. That is, the unlock input reception step s700 in the smartphone 200 shown in FIG. 2 may be replaced with unlock input reception step s700′ in the wearable device 100.

The present invention provides a security level to enable continuous identification of the user who wears the wearable device 100 via continuous checking of connection between the wearable device 100 and the smartphone 200 during use of the smartphone 200.

To this end, the security method in the smartphone according to the present invention further includes checking connection with the wearable device during use of the smartphone 200 (s1000), subsequent to the unlock operation implementation step s900. Sep s1000, in which the smartphone 200 checks connection with the wearable device 100 during use of the smartphone 200, may include: generating an event on the smartphone 200 (s1100); transmitting a request for a connection verification value from the smartphone 200 to the wearable device 100 (s1200); receiving the connection verification value from the wearable device 100 (s1300); and performing a command corresponding to the event (s1400).

In this case, the event generated on the smartphone 200 is preferably one of execution of an application, a system setup change event, and execution of widget.

That is, through the above-described process, the user can unlock the smartphone 200 by performing a simple unlock motion, such as swiping, while maintaining a security level to prevent others from easily using the smartphone, owing to pairing between the wearable device 100, such as a smartwatch, and the smartphone 200.

As is apparent from the above description, in use of a smartphone, the present invention provides a method for unlocking or granting use permission of a smartphone in response to simple swiping or touch motion using pairing with a wearable device while maintaining a security level to prevent others from releasing a lock screen or using an unlocked smartphone.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A security setting and release method in a smartphone using a wearable device, the security setting and release method comprising:
providing a security application installed in the smartphone with device access authority from an operating system (OS) of the smartphone;
requesting that the security application installed in the smartphone commences a service;
checking a wearable device registered in the smartphone;
transmitting a request for a connection verification value from the smartphone to the wearable device;
receiving the connection verification value transmitted from the wearable device to the smartphone;
displaying a lock screen on the smartphone;
receiving an unlock input to the smartphone;
receiving a return value corresponding to the unlock input transmitted from the wearable device to the smartphone; and
performing an unlock operation.

2. The security setting and release method according to claim 1, wherein the displaying includes switching OFF near field wireless communication,
wherein the receiving the unlock input includes: generating a screen touch event the smartphone; and switching ON the near field wireless communication; and
wherein the receiving the return value includes: generating a drag event; and connecting the wearable device and the smartphone to each other via near field wireless communication.

3. The security setting and release method according to claim 1, wherein the receiving the unlock input to the smartphone is replaced with receiving an unlock input to the wearable device.

4. The security setting and release method according to claim 1, further comprising checking connection with the wearable device during use of the smartphone, subsequent to the performing the unlock operation,
wherein the checking the connection includes:
generating an event on the smartphone;
transmitting a request for a connection verification value from the smartphone to the wearable device;
receiving the connection verification value from the wearable device; and
performing a command corresponding to the event on the smartphone, and
wherein the event on the smartphone is one of execution of an application, a system setup change event, and execution of widget.

5. The security setting and release method according to claim 1, wherein, upon determining, in the checking the wearable device, that no registered wearable device is present, the security setting and release method in the smartphone comprises:
searching for the wearable device via near field wireless communication;
transmitting a connection request from the smartphone to the wearable device via near field wireless communication;
transmitting a predetermined personal identification number (PIN) from the smartphone to the wearable device;
receiving a PIN approval result transmitted from the wearable device to the smartphone; and
performing connection between the wearable device and the smartphone.

6. The security setting and release method according to claim 1, wherein, when the wearable device is not connected to the smartphone and does not transmit the connection verification value to the smartphone in response to the request of the smartphone, the security setting and release method comprises:
displaying a predetermined emergency password input window on the smartphone;
inputting an emergency password; and
comparing the input emergency password with a predetermined emergency password.
